(19) United States
(12) Patent Application Publication
(10) Pub. No.: US 2009/0053561 A1
(43) Pub. Date: Feb. 26, 2009

(54) CATALYST LAYERS AND RELATED METHODS

(76) Inventors: Juan Jiang, Orchard Park, NY (US); Albert E. Miller, Granger, IN (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/745,833

(22) Filed: May 8, 2007

Related U.S. Application Data
(60) Provisional application No. 60/798,496, filed on May 8, 2006.

(51) Int. Cl. B32B 15/00; B05D 3/02; B05D 5/12; H01M 4/86; B05D 3/06

(52) U.S. Cl. 429/12; 427/541; 427/77; 427/553; 427/557; 428/615; 428/457

(57) ABSTRACT

Disclosed is a method of preparing a catalyst and a resultant coated substrate. An example method for preparing a catalyst includes dissolving a precursor salt in water to create a dissolved precursor salt. In addition, the method includes adding an ultra-violet sensitizer to the dissolved precursor salt to create a photo emulsion and mixing the photo emulsion with at least one of a surfactant or a stabilizer to create a modified photo emulsion. Further, the modified photo emulsion is applied to a substrate to create a coated substrate, and then the coated substrate is exposed to ultra-violet light. Further, the example method comprises washing the coated substrate after exposing the coated substrate to ultra-violet light and drying the coated substrate after washing the coated substrate.

### RELATED APPLICATION

This application claims priority to co-pending U.S. Provisional Patent Application No. 60/798,496, entitled “Photographic Production of Fuel Cell Catalytic Electrodes,” filed on May 8, 2006, and is hereby incorporated by reference in its entirety.

### GOVERNMENT INTEREST STATEMENT

The United States Government has certain rights in this invention pursuant to Contract No. DAAB07-03-3-K414 with the United States Army.

### FIELD OF THE DISCLOSURE

This disclosure relates generally the preparation of catalysts, and, more particularly, to depositing a catalyst onto a substrate.

### BACKGROUND

Fuel cells are energy conversion devices that produce electrical energy from chemical energy. In a typical fuel cell, a fuel source (e.g., hydrogen gas) is provided at an anode side and an oxidant (e.g., air or oxygen) is provided at a cathode side. The anode and cathode are typically coated with a catalyst such as, for example platinum, palladium, ruthenium, etc or alloys thereof. On the anode side, the fuel diffuses to the anode catalyst and disassociates into protons and electrons. The electrons become the usable electrical energy and the protons move toward the cathode through the electrolyte.

Most current technologies for the fabrication of low temperature fuels cells, such as H₂ proton exchange membrane fuel cells (PEMFCs) and direct methanol fuel cells (DMFCs), rely on the incorporation of layers of ink-based noble metal catalysts near the polymer electrolyte membrane. However, these ink-based catalyst production processes typically do not meet the efficiency, durability and cost requirements for practical use for fuel cells in the modern world. The demand for portable power is rising due to the increasing number of wireless electronic devices in our lives. Miniaturized fuel cells have significant advantages over conventional batteries because of a longer life time, a higher power density and instantaneous recharging. In order for miniaturized fuel cells to be easily integrated into many portable electronic devices and to minimize the production costs, fuel cell fabrication should be compatible with current silicon-based integrated circuit processing technology. Thus, some research has focused on a catalyst production compatible with advanced silicon processing, such as photolithography.

Platinum printing is one of the oldest photolithographic processes used to develop black and white photographs. In a typical platinum printing process, a platinum precursor salt that is used in the process is not light sensitive. Instead, a sensitizer, for example, ferric oxalate Fe₂(C₂O₄)₃, is the light sensitive component and contains iron, the ferric state (Fe³⁺), that easily accepts an electron to change to the ferrous state (Fe²⁺) under UV radiation via a radical-anion mechanism:

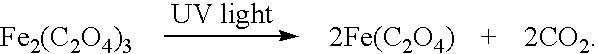

The reduced Fe²⁺ serves as the reducing agent in the development step:

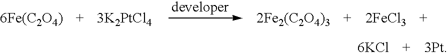

The platinum ions in the precursor salt are reduced and nano-scaled platinum metal particles are deposited onto photographic paper to form black and white images. Developers, such as potassium oxalate, ammonium citrate or sodium citrate, increase the solubility of Fe(C₂O₄) by forming a complex and permitting the platinum producing redox reaction to occur. The development process in platinum printing includes particle nucleation and growth, which is essentially the same as producing metal particles by other chemical reduction methods. However, particle size and deposition efficiency are often uncontrollable in these typical photolithographic printing processes.

### BRIEF DESCRIPTION OF THE DRAWINGS

FIG. 1 is a block diagram showing an example process for creating a catalyst layer.

FIG. 2 shows a block diagram showing the components that comprise an example catalyst layer created in accordance with the example process of FIG. 1, and showing a cross-sectional view of an example substrate with the example catalyst layer created in accordance with the example process of FIG. 1.

FIG. 3 is a transmission electron microscopic view of an example catalyst layer on an example substrate.

FIG. 4A is a scanning electron microscopic view of an example catalyst layer on a carbon paper substrate created through an example print-out process.

FIG. 4B is a scanning electron microscopic view of an example catalyst layer on a carbon paper substrate created through an example develop-out process.

FIG. 4C is a scanning electron microscopic view of an example catalyst layer on a carbon-black-coated carbon paper substrate created through an example print-out process.

FIG. 4D is a scanning electron microscopic view of an example catalyst layer on a carbon-black-coated carbon paper substrate created through an example develop-out process.

FIGS. 5A-D are scanning electron microscopic views of example catalyst layers on a carbon paper substrate created through an example print-out process at varying example reaction temperatures and in varying example hydration environments that produce different catalyst particle sizes.

FIG. 6A is a scanning electron microscopic view of an example catalyst layer printed on a carbon paper substrate creating by mixing ethylene glycol with an example emulsion.

FIG. 6B is a scanning electron microscopic view of an example commercial ink-based air sprayed catalyst layer on a carbon paper substrate for comparison of photo-printed catalyst layer shown in FIG. 6A.

FIG. 6C is a scanning electron microscopic view of an example catalyst layer printed on a carbon-black-coated carbon paper substrate with a modified photo emulsion created by mixing 10 vol % Nafion® ionomer and 18 vol % ethylene glycol at 100k× magnification.

FIG. 6D is a scanning electron microscopic view of an example catalyst layer printed on a carbon-black-coated carbon paper substrate with a modified photo emulsion created by mixing 10 vol % Nafion® ionomer and 18 vol % ethylene glycol at 200k× magnification.

FIG. 7 shows an example catalyst layer applied to an example substrate in an example pattern.

FIG. 8 is an example catalyst layer applied to a second example substrate in a second example pattern to create example electrodes.

FIG. 9 shows four example membrane electrode assemblies.

FIGS. 10A-10D show graphs plotting the mass specific performance of the control membrane electrode assembly of FIG. 9 (the data for which is represented by the □ symbol) and the fourth type of membrane electrode assembly of FIG. 9 (the data for which is represented by the [symbol] symbol) in polymer electrolyte membrane fuel cells at fuel cell temperatures of 50° C. (FIG. 10A), 60° C. (FIG. 10B), 70° C. (FIG. 10 C), and 80° C. (FIG. 10D).

### DETAILED DESCRIPTION

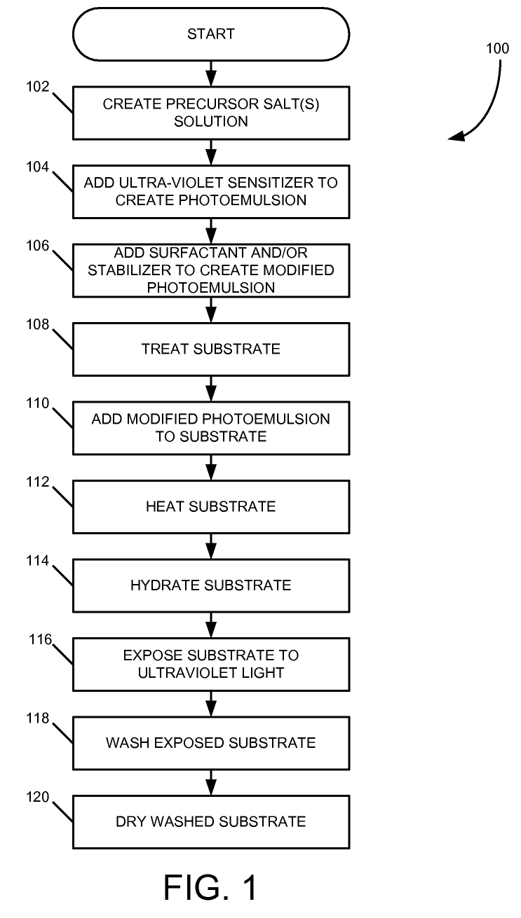

FIG. 1 illustrates an example catalyst layer production process 100. The example catalyst layer production process 100 may be any suitable type of catalyst layer production process such as, for example, a photographic platinum printing process such as a print-out-process (POP). POP differs from a develop-out-process (DOP) in that with a POP, final formation of a catalyst occurs during exposure of a light source (for example, an ultra-violet light, as described in greater detail below); whereas, in with a DOP, a developer (for example, ammonium citrate) is needed to initiate conversion of metal ions in a precursor salt to the state where the reduced metal appears in a catalyst layer. The process 100, described herein is an example POP in which no developer is required and in which a wet development step, which has been required in the prior art, is completely eliminated. As described below, nano-particles of metal catalysts are formed during exposure to, for example, ultra-violet light. Furthermore, as described herein, the example process 100 yielded better control of the catalyst particle size, increased deposition efficiency, and increased mass specific activity of the catalyst layer.

The example catalyst layer production process 100 begins with the preparation of a metal precursor salt solution (block 102). In some examples, more than one precursor salt may be dissolved in the precursor salt solution. After dissolving the precursor salt in, for example, water to create the precursor salt solution (block 102), an ultra-violet sensitizer is added to the dissolved precursor salt to create a photo emulsion (block 104). Next, the photo emulsion is mixed with a surfactant (block 106), which is an agent used to lower the surface tension of liquids to facilitate spreading of the photo emulsion in liquid form. The photo emulsion may also be mixed with a stabilizer (block 106). Once the surfactant and/or the stabilizer has been added (block 106), the mixture is coupled with a substrate (block 110), which may or may not have been treated (bock 108) prior to the application of the mixture. Thereafter, the substrate with the mixture coated thereto is exposed to ultra-violet light (block 116). However, in some examples, the substrate with the mixture coated thereon may be heated for example by baking (block 112) and/or hydrated (block 114) prior to the exposure of the substrate and mixture coupled thereto to ultra-violet light. Upon exposing the substrate and mixture to ultra-violet light (block 116), the substrate and mixture is washed (block 118) and dried (block 120).

Further, although the example processes are described with reference to the flow diagrams illustrated in FIG. 1, persons of ordinary skill in the art will appreciate that other methods of implementing the catalyst layer may alternatively be used. For example, the order of execution of the blocks may be changed, and/or some of the blocks described may be changed, eliminated, and/or combined.

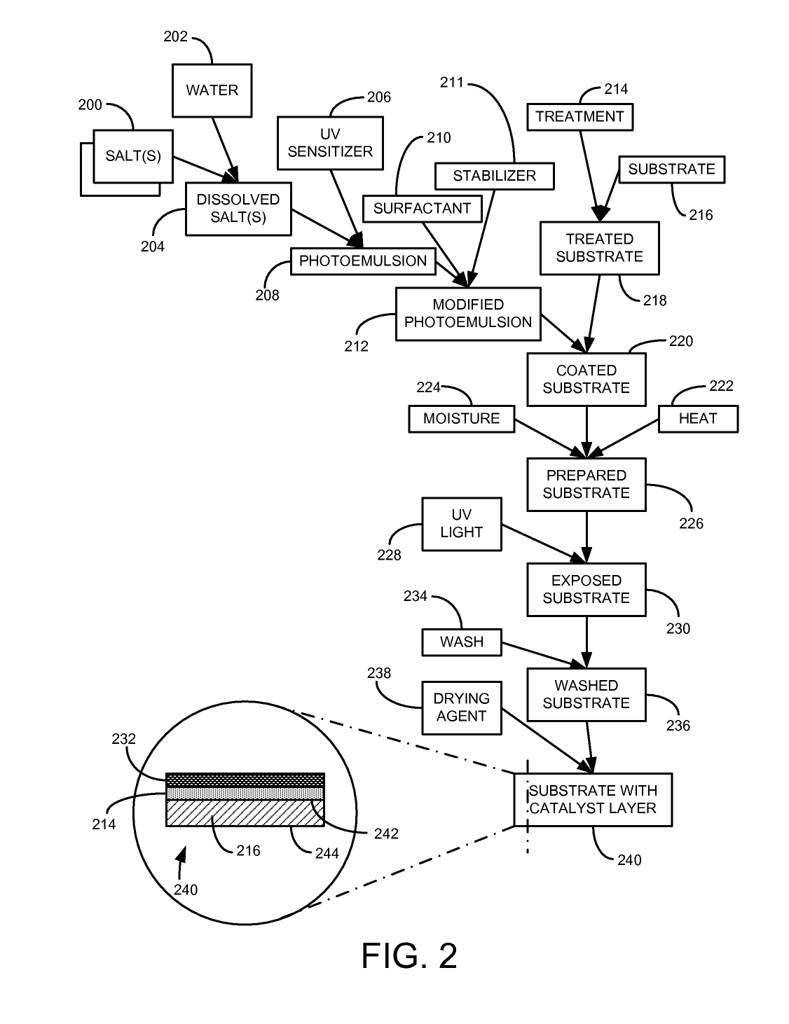

FIG. 2 is a block diagram showing the components that comprise the example catalyst layer created in accordance with the example process of FIG. 1. The encircled portion of FIG. 2 illustrates a cross-sectional view of an example substrate with the example catalyst layer. As shown in FIG. 2, one or more metal precursor salts 200 are added with water 202 to form a dissolved salt solution or metal precursor salt solution 204 which may be, for example, 0.67M aqueous solution of ammonium tetrachloroplatinate ((NH₄)₂[PtCl₄]). It will be appreciated that other metal precursors and other molarities may also be used such as for example, 0.5M. In addition, “added” throughout this description may mean one or more of: combined, mixed, mixed heterogeneously, homogenized, coupled, suspended in, dissipated within, dispersed in, dissolved in, paired, applied to, married, united, joined, blended, etc. Further, the metal precursor salt solution 204 may be created with any type of metal including, for example, ammonium tetrachloroplatinate (NH₄)₂[PtCl₄], other platinum compounds, other ammonium-based chemicals, including metal element such as palladium, rhodium, iridium, lead, mercury, gold, silver, copper, other alloys, and/or any combination thereof. The salts 200 and the water 202 may be added via any suitable process including, for example, the example process described in block 102 of FIG. 1.

The metal precursor salt solution 204 is added (e.g., such as via the example process described in block 104 in FIG. 1) with a ultra-violet sensitizer 206 such as, for example, an ammonium-based chemicals like 1.4M ferric ammonium oxalate, (NH₄)₃[Fe(C₂O₄)₃]. In other examples, the sensitizer 206 may be, for example, ferric oxalate Fe(C₂O₄)₃ or any other suitable sensitizer. The metal precursor salt solution 204 and the sensitizer are added to form a photo emulsion 208. The metal precursor salt solution 204 and the sensitizer 206 may be added in varying percentages including in equal proportions.

A surfactant 210 and/or a stabilizer 211 may be added to the photo emulsion 208 (e.g., via the example process described in block 106 of FIG. 1) to create a modified photo emulsion 212. The surfactant 210 may be any number of compounds including, for example, Nafion® ionomer, which may be added to the photo emulsion 208 to obtain uniform coating of a substrate, as discussed in greater detail below. The stabilizer 211 may be any number of suitable stabilizing substances including, for instance, ethylene glycol (EG). In this example, the EG may be added to the photo emulsion 208 as a stabilizing agent because the EG and/or glycolate, the oxidation product of the EG, attach to metal particles in the precursor salt 204 and act as a stabilizer and prevent nano-particle agglomeration. Further, the addition of the EG 210 gives the modified photo emulsion 212 greater viscosity. Thus, the modified photo emulsion 212 may be applied to substrates by spin-coating, which makes the process (for example, the example process 100 of FIG. 1), more compatible with the manufacture of silicon-based electronic devices and also facilitates the incorporation of micro fuel cell fabrication into the production of electronic devices. In addition, in some examples, the surfactant 210 and stabilizer 211 may be combined in one substance such as, for example, using a Nafion® ionomer as both the surfactant 210 and the stabilizer 211.

A treatment 214 may be added to a substrate 216 to create a treated substrate 218 by, for example, the example process described in, block 108 of FIG. 1. The substrate 216 may be treated with, for example, with carbon black powder and/or a surfactant (e.g., a Nafion® ionomer solution like 5 wt % in lower aliphatic alcohols/H₂O mix). Furthermore, the substrate 216 may be hydrophilic and/or hydrophobic as desired. In this example, the substrate 216 may be a polymer (such as a Nafion® membrane, polyetheretherketone, polyethylene, polypropylene, etc.), a ceramic (such as glass, silicon dioxide or alumina), a paper, a carbon black ink painted paper, a graphite woven sheet, a carbon fiber woven sheet, any other suitable material or any combination thereof. Also, the substrate 216 may be a plate, a tube, a sphere, a block, any other shape or combination of shapes.

The modified photo emulsion 212 is added to the treated substrate 218 by, for example, the example process described in block 110 of FIG. 1. In alternative examples, the modified photo emulsion 212 may be added to the substrate 216 without the prior addition of the treatment 214. The addition of the photo emulsion 212 with the substrate 216 or the treated substrate 218 creates a coated substrate 220. The amount of modified photo emulsion 212 added to the substrate 216 or the treated substrate 218 depends on the desired amount of catalyst surface loading. The modified photo emulsion 212 may be added by printing, spraying, spin coating, spreading, rolling, inking and/or any other method.

The coated substrate 220 may then be treated further by adding heat 222 and/or moisture 224 to the coated substrate 220. The heat 222 may be added, for example, by baking the coated substrate 220 on a hot plate of 170° C. for ten seconds. Also, in the described example, the moisture 224 may be added by resting the coated substrate 220 at two centimeters about the surface of room temperature water for thirty seconds, with the coated faces of the coated substrate 220 toward the water. However, it will be appreciated by one of ordinary skill in the art that the moisture 224 also may be added by any suitable process including, for example, by the hydroscopic action of ammonium salts, by allowing the coated substrate 220 to equilibrate with vapor above a saturated aqueous solution of an inorganic salt such as, for example a saturated CuSO₄ solution, within an enclosure, and/or via steaming (at varying temperature and varying times) or any other method. Control of the amount of moisture 224 controls the particle size of the metals in the catalyst (discussed in greater detail below) and the deposition efficiency.

After the application of the heat 222 (by, for example, the example process described in block 112 of FIG. 1) and/or of the moisture 224 (by, for example, the example process described in block 114 of FIG. 1), the coated substrate 220 becomes the prepared substrate 226, which, in this example, is exposed to ultra-violet (UV) light 228 (by, for example, the example process described in block 116 of FIG. 1) to create the exposed substrate 230. The UV light 228 may originate with, for example, a mercury lamp with an exposure intensity of, for example, 11.5 mW cm⁻² and with a primary exposure wavelength of, for example, 350-500 nm for two minutes, though other exposure intensities (e.g. 2 mW cm⁻²), other wavelengths, and other times (e.g., five minutes) may be used as well. Exposure to the UV light 228 causes nano-metal particles or a catalyst layer 232 to form (i.e., “print” or be retained) on the surface of the exposed substrate 230.

After exposure to the UV light 228, a wash 234 is added to the exposed substrate 230 by, for example, block 118 of the example process of FIG. 1, to create a washed substrate 236 from which sensitizer residue has been removed. The wash 234 may be a highly diluted acid wash such as, for example, 1% hydrochloric acid, 1% oxalic acid or 1% citric acid. In other examples, the wash 234 may be a chelating agent, such as, for example, ethylenediaminetetraacetic acid (EDTA). In other examples, the wash 234 may be water or any other aqueous solution. In one example, the exposed substrate 230 is washed with 500 mL of a 9 wt % EDTA aqueous solution for half an hour, slightly agitated and then further washed with three cycles of 500 mL of water for 30 minutes each time.

Once the wash 234 has been added, the washed substrate 236 is exposed or otherwise treated with a drying agent 238 by, for example, the example process described in block 120 of FIG. 1. The drying agent 238 may be a variety of substances including air. The dried washed substrate 236 becomes the substrate with catalyst layer 240, which may be stored, for example in a desiccator. FIG. 2 shows a cross-sectional view of the substrate with catalyst layer 240. The substrate with catalyst layer 240 includes the substrate 216. Though the substrate 216 may have been treated, coated, prepared, exposed, washed, etc., for the purposes of this description, we refer simply to the substrate 216 as meaning any of the aforementioned substrates 218, 220, 226, 230 and 236. The substrate 216 has a first face 242 and a second face 244. The first face 242 and/or the second face 244 may include the treatment 214 on portions thereof. Though in some examples, the treatment 214 may be absent. In addition, the plurality of nano-metal particles or catalyst layer 232 that precipitated after the application of the UV light 228 appear on at least one of the first face 242 and/or the second face 242 of the substrate 216.

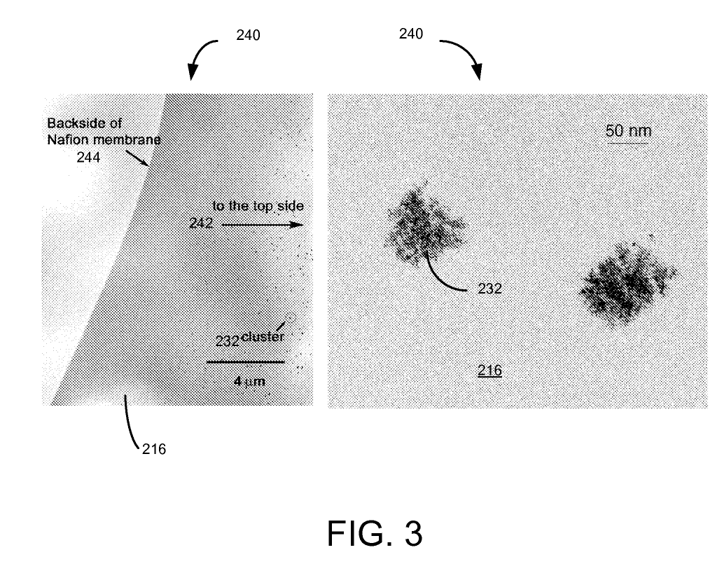

FIGS. 3-6 illustrate the results of printing the nano-metal particles or catalyst layer 232 on the substrate 216 in accordance with the example process 100. For example, FIG. 3 shows a transmission electron microscopic (TEM) view of a cross-section of a portion of the substrate 216 after the metal particles or catalyst layer 232 have been deposited thereon. In the example shown in FIG. 3, the substrate 216 is a Nafion® membrane and the metal particles or catalyst layer 232 are platinum, though other substrates and metal may be used, as discussed above. FIG. 3, also illustrates that the metal particles catalyst layer 232 are not only deposited on the first face 242 (or the second face 244 in other examples) of the substrate 216, but the metal particles catalyst layer 232 may also be embedded into the substrate 216. FIG. 3 also illustrates that the metal particles catalyst layer 232 may be deposited on the substrate 216 in clusters including particles that are less than 5 nm.

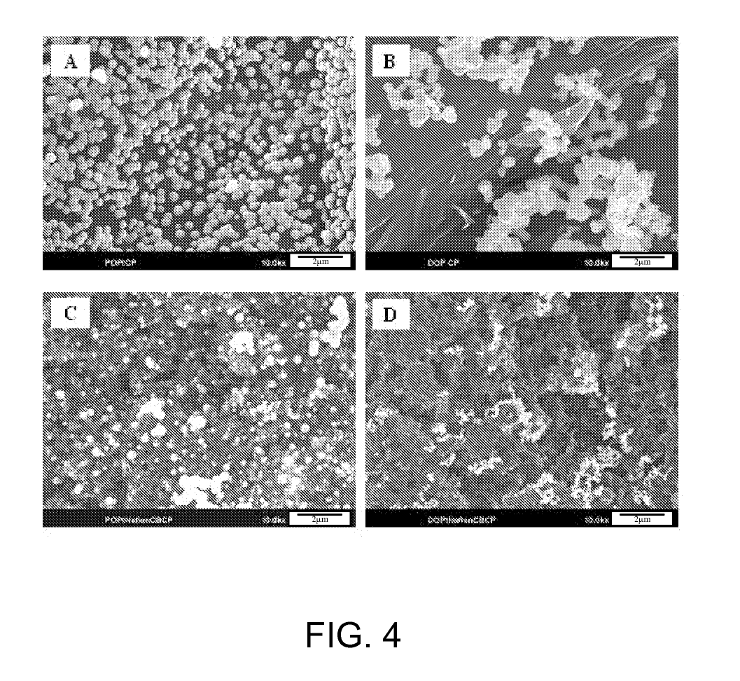

FIG. 4A is a scanning electron microscopic (SEM) view of an example catalyst layer on a carbon paper (CP) substrate created through a print-out process (POP), such as the example process 100 of FIG. 1. In particular, FIG. 4B is an SEM view of an example catalyst layer on a CP substrate created through a develop-out process (DOP, i.e., the prior art). Further, FIG. 4C is an SEM view of an example catalyst layer on a carbon-black-coated carbon paper (CB/CP) substrate created through a POP, and FIG. 4D is an SEM view of an example catalyst layer on a CB/CP substrate created through a DOP. These four images compare the morphologies of the POP metal particles with those of the DOP metal particles on both CP and CB/CP substrates. Samples B and D were made by DOP, exposed under UV for five minutes and developed with ammonium citrate. Sample A and C were steamed with 90° C. water for 30 seconds and exposed to UV light for one minute. The difference between sample A and C is that for sample C, 10 vol % Nafion® ionomer solution was mixed with a photo emulsion (i.e., the photo emulsion was modified by adding a surfactant) because the substrate is CB/CP. From the images, it can be seen that the deposition efficiencies on both substrates (i.e., CP and CB/CP) were dramatically improved by the POP. For example, the deposition efficiency may have increased from 2.6% to 13.4% with CP and from 0.49% to 11.3% with CB/CP. The images in FIGS. 4A-D also show that the POP metal (e.g., platinum) particles are more dispersed and of a more uniform size than those produced by the prior art (e.g., the DOP).

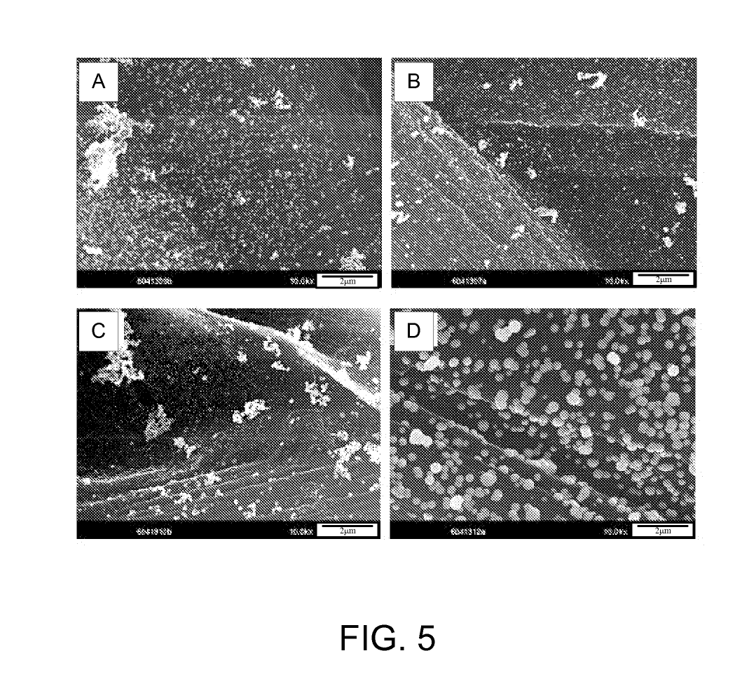

FIGS. 5A-D are SEM views of example catalyst layers on a CP substrate created through a POP such as the process 100 at varying example reaction temperatures and in varying example hydration environments to illustrate and compare metal particle size control mechanisms. The substrate of sample A was baked and exposed to UV light when the substrate was still hot. The redox reaction rate and the diffusion of ions to form the metal (e.g., platinum) particles are enhanced over the other methods described in the Samples B-D. However, the moisture content of the substrate in Sample A is low; therefore, the size of the metal particles is in the intermediate range (e.g., 80-180 nm). In Samples B and C, the substrate was hydrated with water at or below 50° C. In these samples, the water vapor was absorbed by the hygroscopic ammonium based salts in the photo emulsion and the metal producing redox reaction was restricted to small regions due to a relatively low mobility of the ions. Therefore, the metal particles produced in the hydrated conditions of Samples B and C were in the small range (e.g., 50 nm or smaller, depending on the hydration conditions). In Sample D, the substrate was hydrated with 90° C. water. This caused visible water droplets to form on the substrate (e.g., CP). In these samples, the metal formation redox reaction takes place in a large volume of liquid as evidenced by the presence of condensed water. The presence of a relatively large amount of liquid enables the nuclei of the metal particles to grow larger because of the high mobility of the ions in liquid phase. Thus, the metal particles were relatively large (e.g., similar to particles obtained via the DOP processes illustrated in FIGS. 4B and 4D). Thus, small metal particles are formed when no condensed water is present on the substrate and temperatures are low. Therefore, FIGS. 5A-D illustrate that POP not only improves the dispersion of the metal particles and narrows the size distribution among metal particles, but also that metal particles of varying sizes may be created by controlling the process conditions including, for example, the amount of hydration and the temperature.

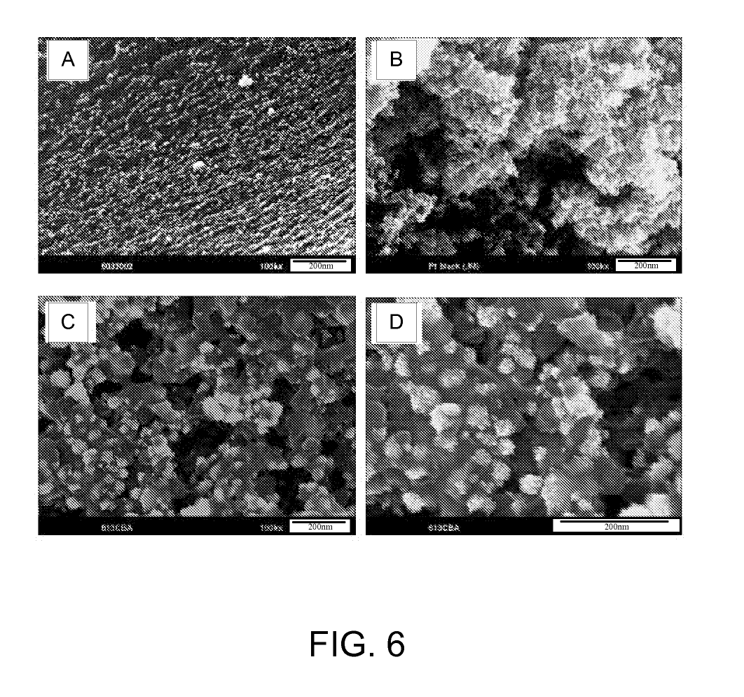

FIG. 6A is an SEM view of an example catalyst layer printed on a CP substrate creating by mixing EG with an example emulsion. FIG. 6B is an SEM view of an example commercial ink-based catalyst layer air sprayed on a CP substrate. FIG. 6C is an SEM view of an example catalyst layer printed on a carbon-black coated CP substrate with a surfactant (e.g., 10% Nafion® ionomer) and a stabilizer (EG) mixed in with an example emulsion at 100k× magnification, and FIG. 6D shows the same structure at 200k× magnification. A comparison of Sample A with Sample B shows that the POP with the addition of the stabilizer, e.g., EG (i.e., Sample A), prevents the particles from agglomerating as seen in Sample B. Furthermore, when both a stabilizer and a surfactant are added (i.e., Samples C and D) and when printed onto a more hydrophobic substrate such as, for example, carbon-black coated carbon paper (CB/CP), not only are the particles retained, for example, as 25 nm clusters including 5 nm particles, but the coating of metal particles also is more uniform.

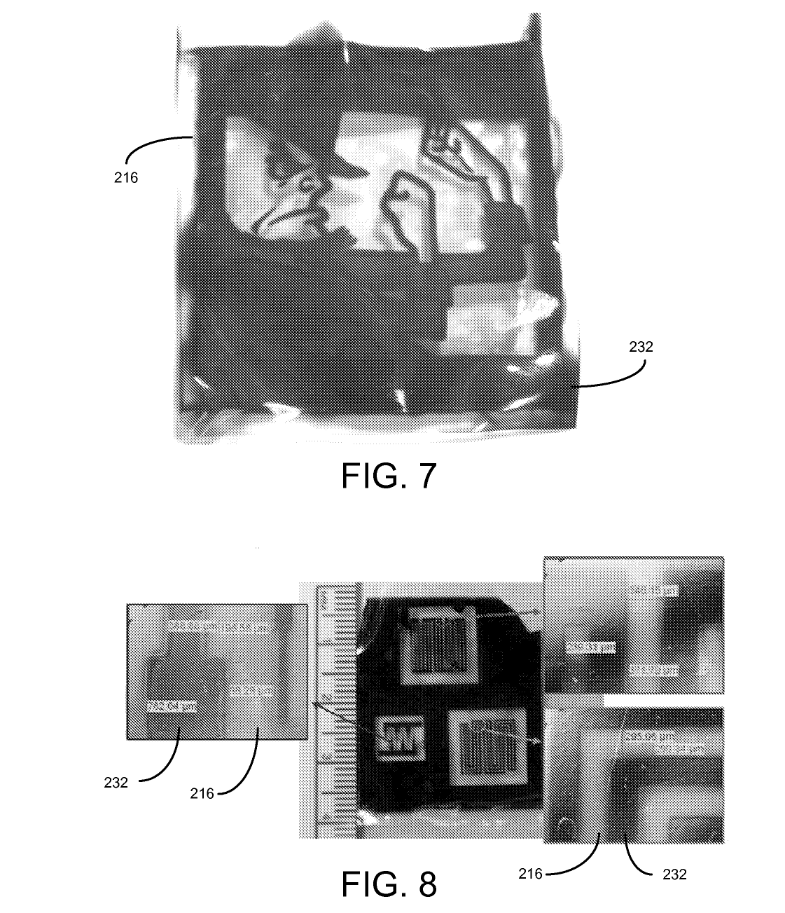

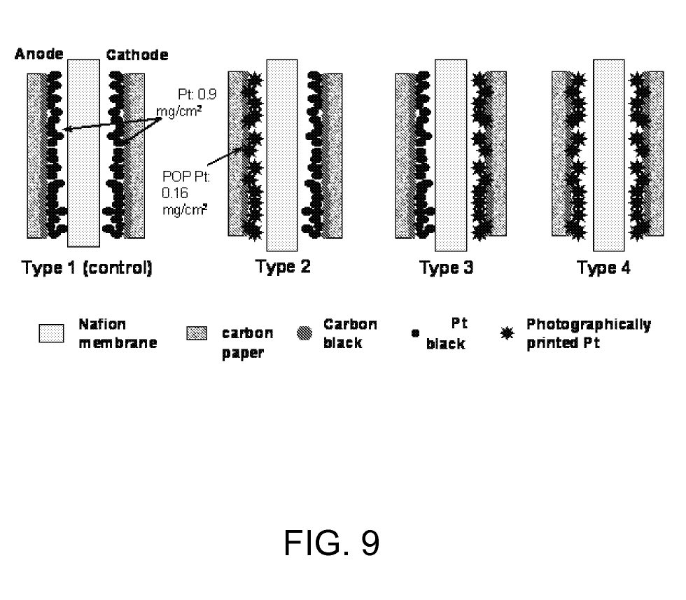

FIGS. 7 and 8 shows two examples in which the deposition of the metal particles maybe manipulated by, for example, any of the methods described above, to create patterns of deposited metal particles on a substrate. FIG. 7 shows the metal particles 232 deposited on the substrate 216 (e.g., a Nafion® membrane) in a pattern to form an image of a logo such as the Fighting Irish logo of the University of Notre Dame. FIG. 8 shows the metal particles 232 deposited on the substrate 216 (e.g., a Nafion® membrane) in a pattern to form flow fields that may be used as electrodes in a fuel cell application.

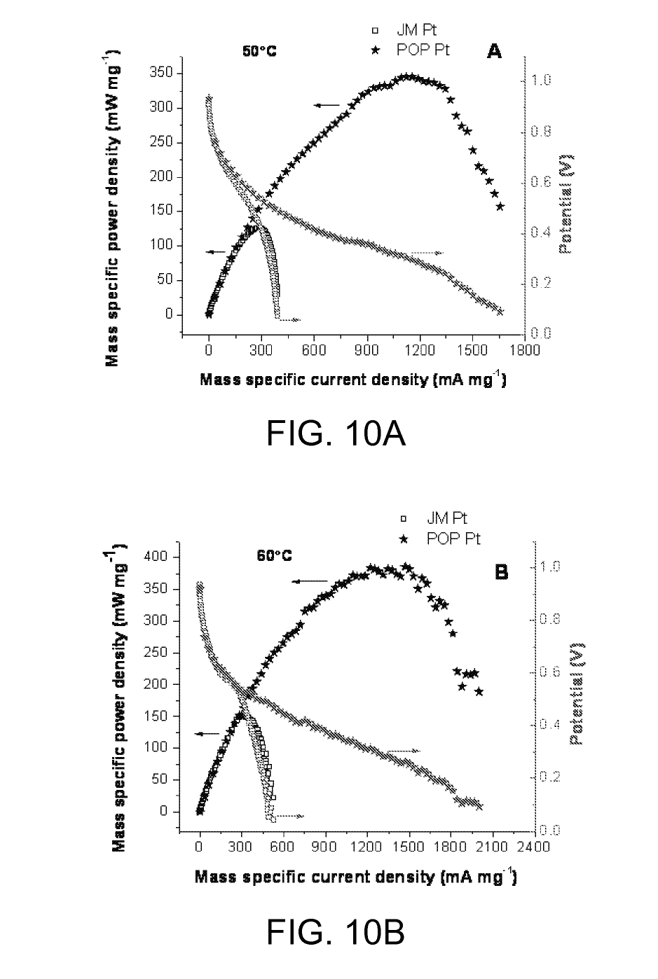

FIG. 9 shows four example membrane electrode assemblies (MEAs) that may include a catalyst layer such as the catalyst layer 240 described above, which may be used in fuel cells. Type 1 is a control MEA, which includes an air-sprayed ink-based commercial platinum black on CB/CP as both the anode and the cathode. The catalyst loading on the substrate may be detected by a method such as, for example, Inductively Coupled Plasma-Optical Emission Spectroscopy (ICP-OES). In the Type 1 control MEA, the ICP platinum loadings are the same on both the anode and the cathode (e.g., 0.9 mg cm⁻²). The next three types may use the example process 100 of FIG. 1 to deposit metal particles as the catalyst layer on one or more of the anode and/or cathode as described herein. The second type of MEA has POP platinum as the anode catalyst, with a lower ICP platinum loading of, for example, 0.16 mg cm⁻². The platinum was photographically deposited by the modified POP (e.g., the example process 100 of FIG. 1) onto the same CB/CP as used in the control. The third type of MEA has the POP platinum as the cathode catalyst, with an ICP platinum loading of, for example, 0.16 mg cm⁻². Further, the anode in the third type of MEA was identical to that in the control. The fourth type of MEA uses POP platinum as both the cathode and the anode catalysts, with an ICP platinum loading of, for example, 0.16 mg cm⁻² on both the cathode and the anode. Any of these types of MEAs may be used in fuel cells.

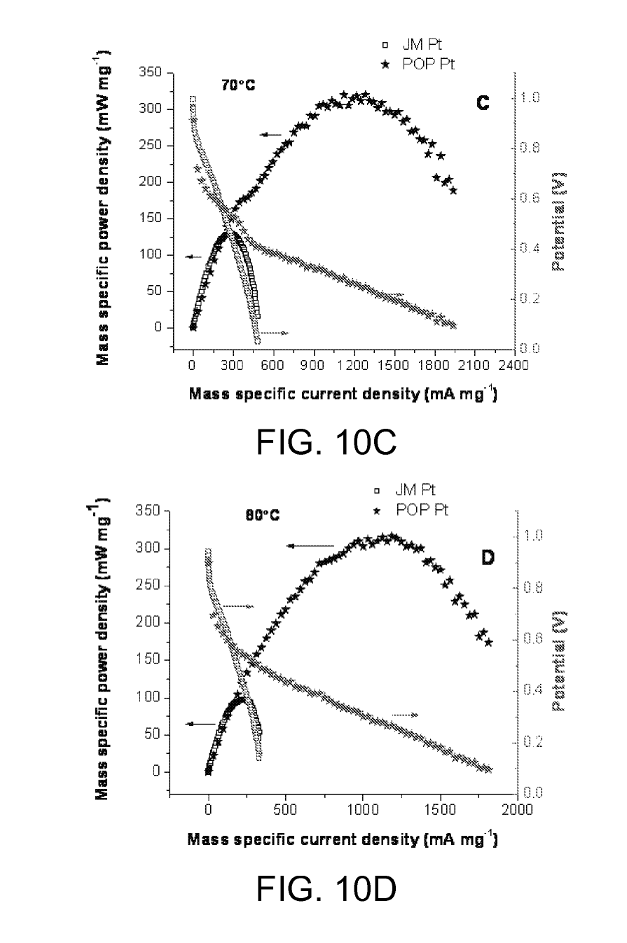

FIGS. 10A-10D show example performance curves for the control MEA of FIG. 9 (the data for which is represented by the □ symbol and the fourth type of MEA, the data from which is represented by the [symbol] symbol in polymer electrolyte membrane fuel cells (PEMFCs) at fuel cell temperatures of 50° C. (FIG. 10A), 60° C. (FIG. 10B), 70° C. (FIG. 10 C), and 80° C. (FIG. 10D). The active area of the PEMFC in this example is 5 cm². The PEMFC in this example is at 100% RH (relative humidity) and ambient pressure. In addition, in this example pure H₂ and O₂ are used as the anode and cathode fuel, respectively. Further, the flow rate in this example is 0.1 L min⁻¹ for both H₂ and O₂. Other values and materials may be used in other examples.

In this example, the example performance curves show the mass specific power density (power density divided by the total catalyst loading) versus the mass specific current density (current density divided by the total catalyst loading). Comparing the control MEA to the fourth type MEA (which, as described above with respect to FIG. 9 has 0.16 mg cm⁻² POP platinum on both the anode and the cathode sides), the mass specific peak power densities are enhanced by a factor of 3 in the cell temperature range from 50° C. to 80° C. Thus, the catalyst produced by the modified POP (i.e., the example process 100 of FIG. 1) is more active due to the reduction of particle size and the elimination of particle agglomeration, as described above.

As described above, photographic printing may be used to deposit nano-sized particle of metal catalysts (e.g., platinum, palladium, and/or their alloys) onto various substrates. These metal catalyst deposition techniques are compatible with photolithographic techniques that are used in semiconductor manufacturing to fabricate micro fuel cells. Catalysts in fuel cells facilitate the reaction of the oxidant (e.g., oxygen) and the fuel (e.g., hydrogen). Metal catalysts in fuel cells are typically deposited on the substrate to maximize the exposed surface area of the metal. The printing/deposition processes described herein can produce very small (e.g., 5 nm) particles that are uniformly spread to prevent agglomeration. Further, one of ordinary skill in the art would appreciate that the metal catalysts printed by the above-described methods has good adhesion with Nafion® membrane and good mass-specific catalytic activity compared to known platinum catalysts. Also, the deposition process described herein does not affect membrane proton conductivity in a fuel cell. Therefore, more power can be generated in a fuel cell using the catalyst produced by the process described herein.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method for preparing a catalyst, the method comprising:
dissolving a first precursor salt in water to create a dissolved precursor salt;
adding an ultra-violet sensitizer to the dissolved precursor salt to create a photo emulsion;
mixing the photo emulsion with at least one of a surfactant or a stabilizer to create a modified photo emulsion;
applying the modified photo emulsion to a substrate to create a coated substrate;
exposing the coated substrate to ultra-violet light;
washing the coated substrate after exposing the coated substrate to ultra-violet light; and
drying the coated substrate after washing the coated substrate.

2. A method as defined in claim 1, further comprising dissolving a second precursor salt in water with the first precursor salt.

3. A method as defined in claim 1, wherein at least one of the surfactant or the stabilizer is a Nafion® ionomer solution.

4. A method as defined in claim 1, wherein the stabilizer is ethylene glycol.

5. A method as defined in claim 1, further comprising treating the substrate prior to the application of the modified photo emulsion.

6. A method as defined in claim 5, wherein the substrate is treated with a coating of carbon black powder and Nafion® ionomer solution.

7. A method as defined in claim 1, further comprising baking and hydrating the photo emulsion coated substrate prior to being exposed to ultra-violet light.

8. A method as defined in claim 7, wherein the coated substrate is hydrated by resting the coated substrate above a surface of room temperature water with a coated side of the coated substrate facing the surface of room temperature water.

9. A method as defined in claim 7, wherein the coated substrate is hydrated with steam.

10. A method as defined in claim 1, wherein the coated substrate is washed with ethylenediaminetetraacetic acid.

11. A method as defined in claim 1, wherein the first precursor salt and the ultra-violet sensitizer are ammonium-based chemicals.

12. A method as defined in claim 11, wherein the first precursor salt includes ammonium tetrachloroplatinate.

13. A method as defined in claim 11, wherein the ultra-violet sensitizer is ferric ammonium oxalate.

14. A method as defined in claim 1, further comprising using the coated substrate as an electrode in a fuel cell.

15. A method as defined in claim 1, wherein the substrate is at least one of a polymer, a ceramic, a paper, a graphite woven sheet, or a carbon fiber woven sheet.

16. A method as defined in claim 1, wherein the substrate is at least one of a sheet, a plate, a tube, a sphere, a block, or any other shape or combination of shapes.

17. A method as defined in claim 1, wherein the substrate is hydrophilic or hydrophobic.

18. A method as defined in claim 1, wherein applying the modified photo emulsion includes at least one of spreading, spraying, dipping, or spin coating.

19. Means for controlling a size of a plurality of metal particles during the preparation of a catalyst, the means comprising:
means for creating a dissolved precursor salt associated with the metal;
means for creating a modified photo emulsion that includes the dissolved precursor salt, an ultra-violet sensitizer, and at least one of a surfactant or a stabilizer;
means for applying the modified photo emulsion to a substrate to create a coated substrate;
means for depositing and retaining at least some of the plurality of metal particles on the coated substrate.

20. Means for controlling a size of a plurality of metal particles during the preparation of a catalyst as defined in claim 19, wherein the metal is at least one of platinum, palladium, rhodium, iridium, lead, mercury, gold, silver, or copper.

21. Means for controlling a size of a plurality of metal particles during the preparation of a catalyst as defined in claim 19, wherein the precursor salt is ammonium tetracholorplatinate.

22. Means for controlling a size of a plurality of metal particles during the preparation of a catalyst as defined in claim 19, wherein the ultra-violet sensitizer is ferric ammonium oxalate.

23. Means for controlling a size of a plurality of metal particles during the preparation of a catalyst as defined in claim 19, wherein the means for depositing and retaining at least some of the plurality of metal particles on the coated substrate includes exposing the coated substrate to ultra-violet light.

24. Means for controlling a size of a plurality of metal particles during the preparation of a catalyst as defined in claim 23, further comprising means for baking and hydrating the coated substrate prior to exposing the coated substrate to ultra-violet light

25. A metal-deposited substrate comprising:
a first face; and
a second face,
wherein at least one of the first face or the second face includes a plurality of metal particles that precipitated after the application of ultra-violet light to the substrate upon the coating of the substrate with a modified photo emulsion that includes a dissolved precursor salt, an ultra-violet sensitizer, and at least one of a surfactant or a stabilizer.

26. A metal-deposited substrate as defined in claim 25, wherein the precursor salt and the ultra-violet sensitizer are ammonium-based chemicals.

27. A metal-deposited substrate as defined in claim 25, wherein the substrate is hydrated prior to the application of ultra-violet light.

28. A metal-deposited substrate as defined in claim 25, wherein the substrate is an electrode in a fuel cell.

29. A metal-deposited substrate as defined in claim 25, wherein the metal is one or more of platinum, palladium, rhodium, iridium, lead, mercury, gold, silver, copper.
